(19) United States
(12) Patent Application Publication
(10) Pub. No.: US 2008/0166686 A1
(43) Pub. Date: Jul. 10, 2008

(54) DASHBOARD FOR MONITORING A CHILD'S INTERACTION WITH A NETWORK-BASED EDUCATIONAL SYSTEM

(76) Inventors: Cristopher Cook, Seattle, WA (US); Cheryl A. Dodge, Sacramento, CA (US); Lou Gray, Bellevue, WA (US); Nigel J. Green, Bellevue, WA (US); Roy Leban, Redmond, WA (US); Benjamin W. Slivka, Clyde Hill, WA (US); Mickelle Weary, Kirkland, WA (US)

Correspondence Address: HAHN AND MOODLEY, LLP, P.O. BOX 52050, MINNEAPOLIS, MN, 55402, US

(21) Appl. No.: 11/969,874

(22) Filed: Jan. 4, 2008

Related U.S. Application Data
(60) Provisional application No. 60/883,366, filed on Jan. 4, 2007.

(51) Int. Cl. G09B 5/14; G09B 5/02

(52) U.S. Cl. 434/118; 434/430

(57) ABSTRACT

Embodiments of the invention provide a network-based educational system comprising educational content that is presented to a child in an interactive session; and a reporting function to report via an interactive dashboard on various aspects of the child's interaction with the educational content.

This application claims the benefit of priority to U.S. Provisional Patent Application No. 60/883,366 filed Jan. 4, 2007, the specification of which is hereby incorporated by reference.

### FIELD

Embodiments of the present invention relate to computer-based instruction.

### BACKGROUND

Computer-based instruction involves the presentation of instructional/educational content to a user by means of a computer. The educational content is embodied in a software program which presents the educational content to the user in an interactive manner.

### SUMMARY OF THE INVENTION

According to a first aspect of the invention, there is provided a network-based educational system comprising educational content that is presented to a child in an interactive session; and a reporting function to report on various aspects of the child's interaction with the educational content via a network. The network may be the World Wide Web (hereinafter “the web”).

In one embodiment, a report may be presented to a parent or teacher of the child in the form of an email message that is sent periodically to the parent or the teacher. The content of the report and its periodicity may be selected by the parent or teacher.

The report may comprise an overview of the child's use of the network-based educational system. The overview may comprise metrics on the child's progress within the network-based educational system; the child's mastery of skills mapped to objectives within the child's grade level; and the child's progress mapped to local/national standards.

The report may comprise example questions presented to the child and definitions of learning experiences.

The report may comprise usage metrics such as the amount of time spent using the system, e.g. by session, or by range of dates e.g. weekly, monthly, etc. The usage metrics may also comprise the days in a week the network-based system was used, an indication of the days that the child appears to demonstrate an increased learning ability, the child's missed days i.e. the days that child did not use the network-based educational system; and the days the child showed a diminished capacity for learning.

In one embodiment, the report may comprise detailed information about the learning experiences of the child, e.g. the specific concepts learned, information on the specific themes, e.g. dinosaurs, pirates, space etc., and content the child is using.

In some cases the network-based educational system may have developed new graphics and themes. The new graphics and themes may be presented to the parent or teacher for approval. If the new graphics and themes are approved then they may be included in content shown to the child. Otherwise, the new graphics and themes are not included with the content shown to the child.

Other aspects of the invention will be apparent from the detailed description below:

### BRIEF DESCRIPTION OF THE DRAWINGS

FIG. 1 shows a network comprising a server and a client device, in accordance with one embodiment of the invention;

FIGS. 2a to 2f show web pages designed to capture registration information, in accordance with one embodiment of the invention;

FIGS. 3 to 4 illustrate aspects of a dashboard in accordance with one embodiment of the invention; and

FIG. 4 shows a block diagram of hardware that may be used to implement the client device or the server of FIG. 1, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the present invention provide a network-based educational system for teaching learners such as children. The network-based educational system is able to generate a report on various aspects of a child's interaction with the system. The report is presented to a reviewer in the form of a parent or teacher of the child so the parent or teacher can gain valuable insight into the child's learning progress and patterns with the system. The report can be sent to the parent or teacher on a regular basis. Alternatively, the parent or teacher can log into the system and view the report.

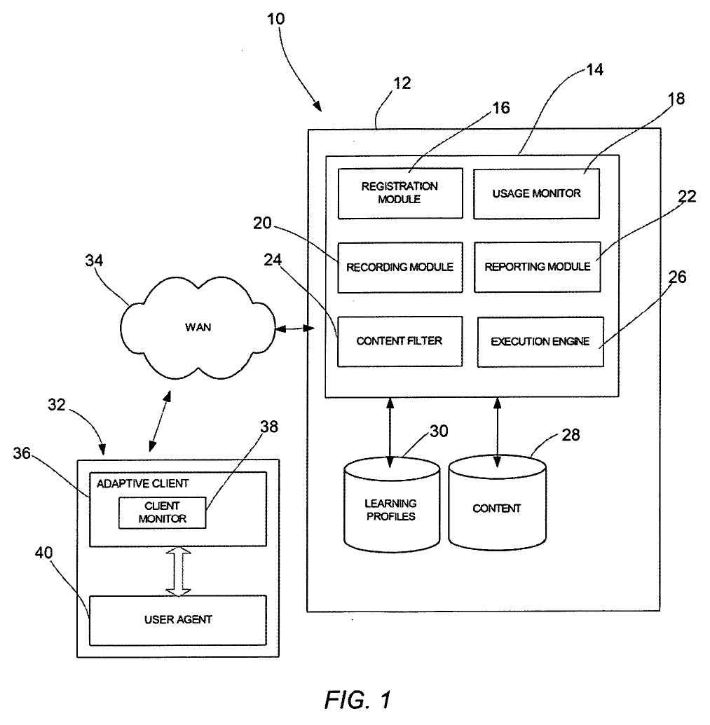

Referring now to FIG. 1 of the drawings, there is shown a network-based educational system 10, in accordance with one embodiment of the invention, implemented as a server 12. The server 12 comprises a learning executive 14 which includes logic to interactively present educational content to a child and to monitor the child's mastery of the educational content. The educational content may be from different disciplines such as history, music, math, languages, etc. As will be seen, the learning executive 14 comprises various modules/components including a registration module 16, a usage monitor 18, a recording module 20, a reporting module 22, a content filter 24, and an execution engine 26. The registration module 16 performs a registration operation to collect registration information. The usage monitor 18 monitors aspects of a child's usage of the system 10. The content filter 24 determines what content to allow or block as will be described in greater detail below. The reporting module 22 controls the creation of detailed reports on a child's interaction with the system 10 so that a parent or teacher can gain insight into the child's learning with the system 10. The execution engine 26 controls the presentation of educational content to a child and may adaptively select the content that is presented to the child based on the client's interaction with the content. The learning executive 14 is coupled to a content database 28 and to a learning profile database 30

The server 12 is connectable to a client device 32 via an intermediate Wide Area Network (WAN) 34, which in some embodiments comprises the Internet. The client device 32 represents the mechanism whereby a child/leaner can gain access to the network-based educational system 10 and to engage in an interactive session therewith. Thus, the client device may be a desktop computer, a laptop computer, a Personal Digital Assistant (PDA), a mobile phone, etc. The client device 32 comprises an optional adaptive client 36 which is essentially a software component that implements logic to implement functions and tasks related to the provision of online instruction by the server 12. For example, the adaptive client 36 may implement a client monitor 38 to perform a monitoring function that will be explained later. The client device 32 also includes a User Agent (UA) 40 to facilitate interaction with educational content from the server 12. The UA 40 may include a web-browser.

As noted above, one of the advantages of the network-based educational system 10 is its ability to provide a detailed report on a user's interaction with the system. A specific implementation of the system 10 has been shown in FIG. 1. However, it is to be understood that this example is intended to be non-limiting. In general, in order to provide the detailed report, the system 10 will have one or more server applications to process content data and student/learner data in the form of learning profiles and to compile the data into a client readable format that is then sent over the WAN to the client for playback and viewing. For example, in one embodiment, the data may be compiled into SWF (Flash) format which is then read by client software on the client device 32 and displayed through the Adobe Flash player. In other embodiments, the compilation may be in the form of HTML, AJAX/DHTL or even C++ depending on future implementation of client and server software.

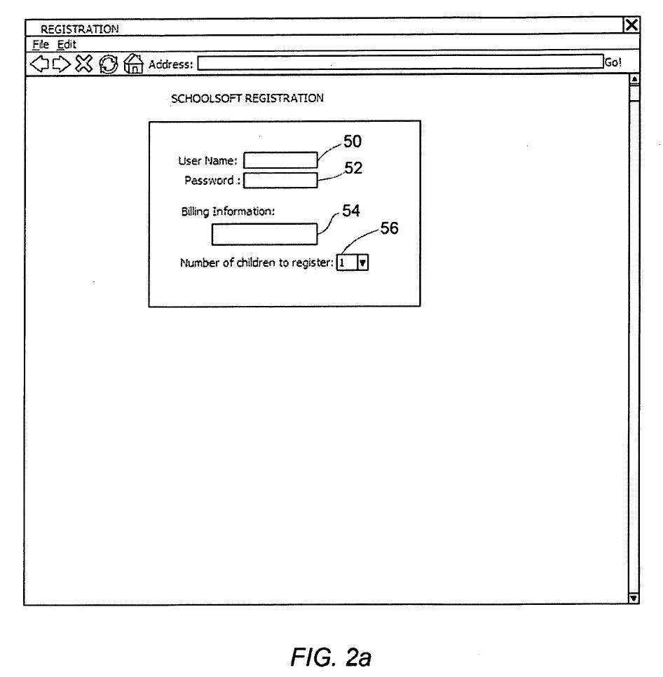

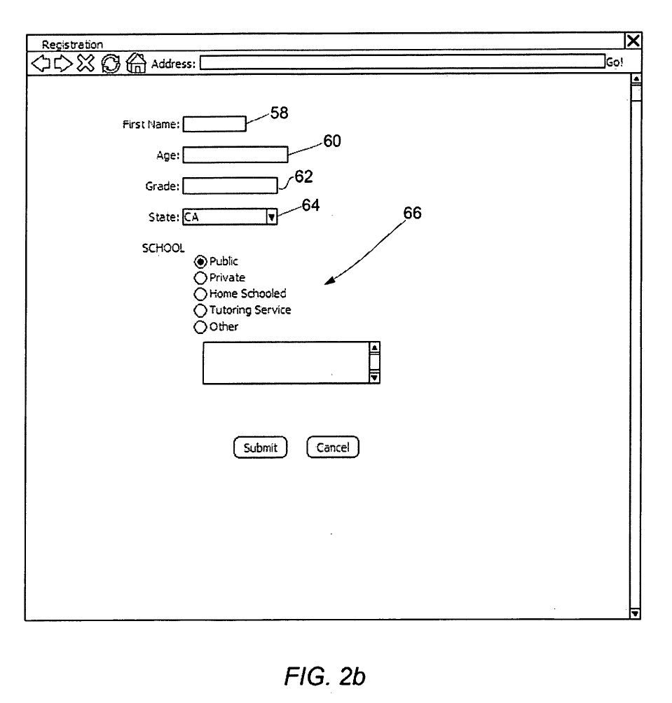

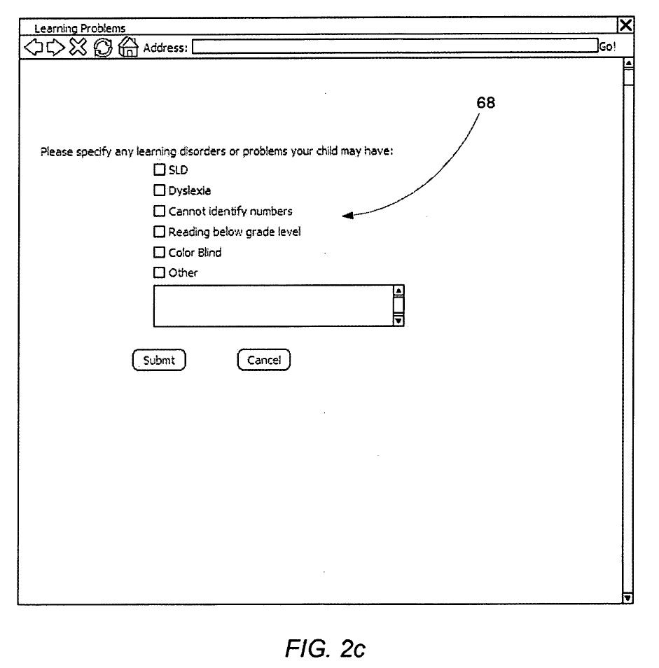

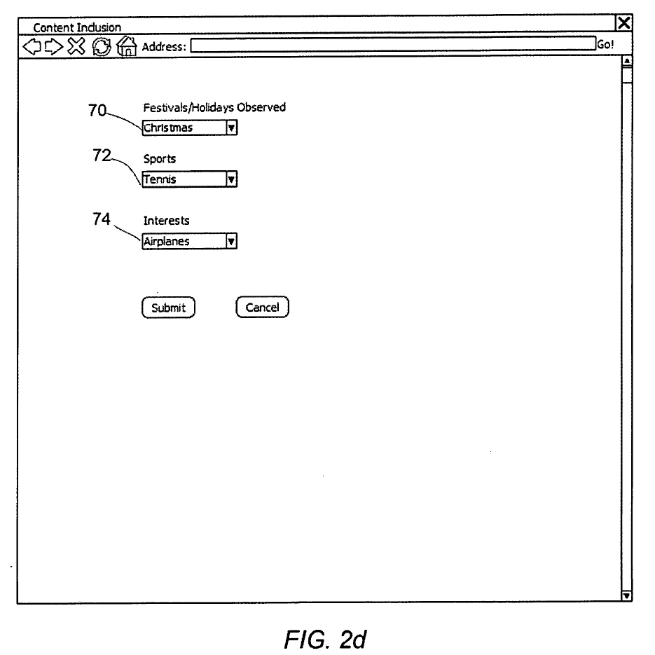

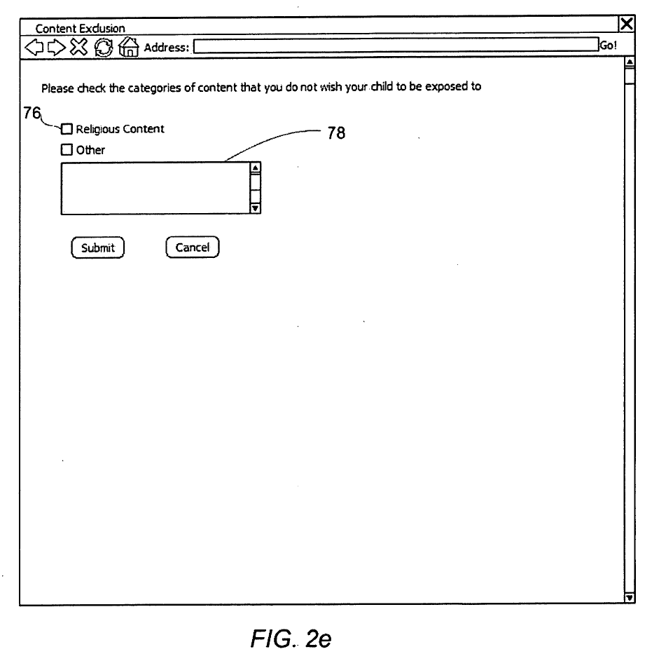

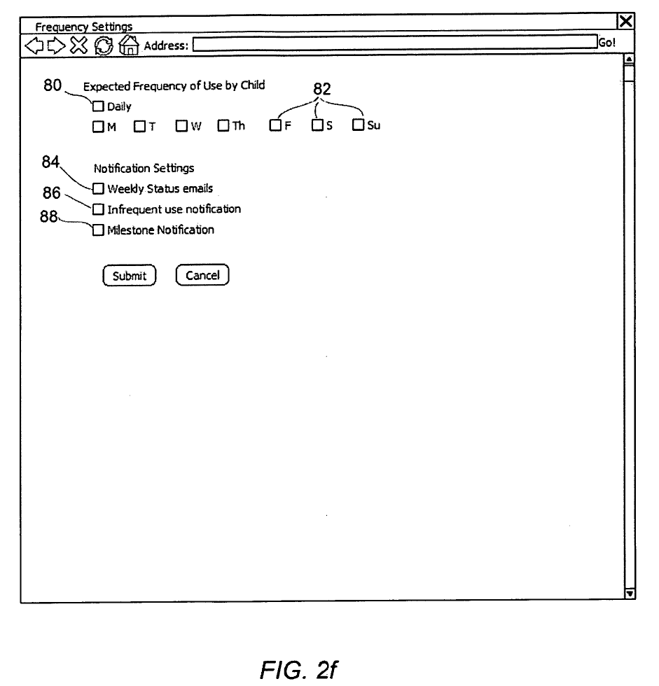

In order to provide such a detailed report, in one embodiment a registration operation is performed. The goal of the registration operation is to capture: (a) information about a child/learner; and (b) user preferences relating to the generation of the detailed report. It will be appreciated that given the goal of the registration operation, it is possible to implement the registration operation in a variety of ways. One such way is illustrated with reference to FIGS. 2a to 2f which show mockups of web pages that would be rendered by the UA 40 in one embodiment as part of the registration operation. Starting with FIG. 2a, the user, e.g. the parent of the child learner that will ultimately use the network-based educational system 10, is prompted to register by entering a user name 50 and a password 52. The input user name 50 and password 52 collectively define parent login information that will allow the parent access to the system 10 for the purpose of viewing the detailed reports of the present invention. The parent may also be required to enter billing information 54, e.g. in the form of credit card information, if the educational content is provided by the system 10 on a paid subscription basis. In box 56, the number of children that are to use the system 10 is provided.

Next, the parent is shown the web page of FIG. 2b multiple times, once for each child that is to be registered. Information for each child, e.g. the child's first name 58, age 60, grade 62, and state 64 is provided by the parent. In area 66 information on the type of schooling the child is currently undergoing is provided. In some embodiments (not shown) the web page of FIG. 2b may be designed to capture login information for each child, i.e. the user name and the password that the child would use in order to gain access to the system 10.

Following the web page of FIG. 2b, the parent is shown the web page of FIG. 2c, in accordance with one embodiment. The web page of FIG. 2c comprises an area 68 to capture learning disorders or problems that a particular child may be currently experiencing. The learning disorders may be actual medical conditions or they may be “areas of concern” that a parent/teacher may have for a particular child.

In web page 2d, box 70 is a drop down box that is designed to capture the festivals/holidays that are relevant to a particular child. The idea with capturing this type of information is to use this information to avoid exposing the child to culturally irrelevant material and conversely to expose the child to culturally relevant material. For example, for a family that observes or celebrates Easter, content and themes pertaining to Easter will be shown to a child of that family, but not to a child of a family that has not selected Easter from the drop down box 70. Likewise information about a child in the form of sports that the child may be interested in, or the child's interests may be captured via drop down boxes 72, and 74, respectively.

The information collected via the web page of FIG. 2d represents information that is used to decide what themes and content to include for a particular child. By means of the web page of FIG. 2e, information is collected to control what themes and content to exclude for a particular child. By way of example, the check box 76 capture input to control whether the child is to be exposed to religious content. In general, content that a parent does not wish their child to be exposed to may input via the box 78.

The information that is collected pursuant to the web page of FIGS. 2d and 2e is used by the content filter to determine what content and themes to allow or block for a particular child.

Via the web page of FIG. 2f, input regarding settings for the detailed reports is captured. For example, via check box 80, a daily expected frequency of use of the system 10 may be input. Via the check boxes 82, the days of the week that a child is expected to use the system 10 may be input. The check box 84 is designed to capture an indication if the detailed report is to be emailed to the parent on a weekly basis. By checking the check box 86, a parent may indicate that he/she wishes to receive an “infrequent use notification”. The infrequent use notification may be generated if the child's actual use deviates from the actual use by a predefined amount. The system 10 may also generate a “milestone notification” to a parent if the check box 88 is checked. In one embodiment, a milestone notification to a parent is generated if a particular milestone is reached. Milestones may be predefined in the system 10 or they may be defined by a parent. An example of a milestone includes a child reaching a certain proficiency in a particular subject. For parent or user-defined milestones, a web page may be presented to the parent in order to capture the milestones.

The data captured via the web pages 2a to 2f is stored in the form of a parent profile and associated child profile in the profile database 30. The registration module 16 embodies logic to manage collection of the registration information described above and its subsequent storage in the parent and child profiles.

The usage monitor 18 comprises logic to monitor various usage parameters relating to a child's usage of the system 10. The usage parameters may include a date and time of each interactive session that a child has with the system 10, the duration thereof, etc.

The recording module 20 comprises logic to record representative aspects of the child's interaction with the system 10 for presentation via a playback function to a parent in a detailed report so that the parent can gain insight into the type of learning experiences the system 10 provides to the child. In some embodiments, the module 20 records a simple textual account of questions presented to a child in a session, the activities that the child was engaged with in that session, as well the child's responses to the questions. In another embodiment, the recording module 20 may record sufficient information about a representative interaction between a child and the system 10 so as to allow a parent to view an actual screen replay of the interaction as part of a detailed report. For example, from a screen replay, a parent will be able to see a child's actual interaction with the system. Elements of the interaction may include events such as mouse movement, mouse clicks, requests for help/guidance, length of time taken to solve a problem, etc.

The reporting module 22 comprises logic to compile detailed reports regarding a child's interaction with the system 10 and to present the reports to a parent, in accordance with preferences set by the parent.

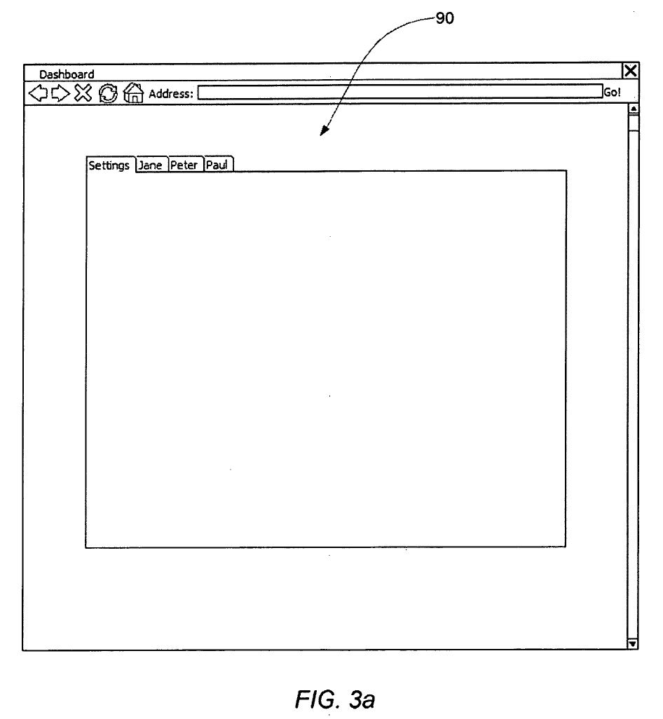

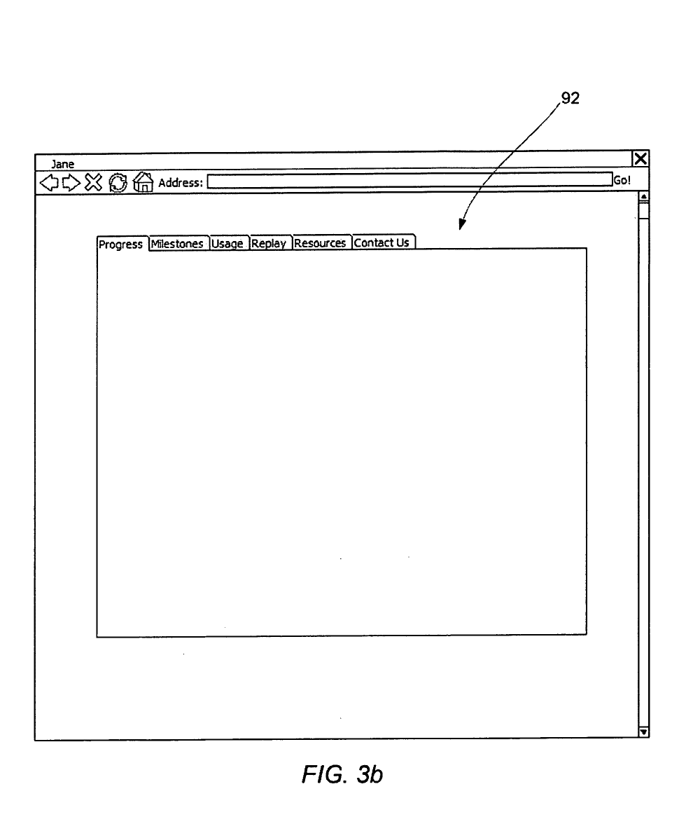

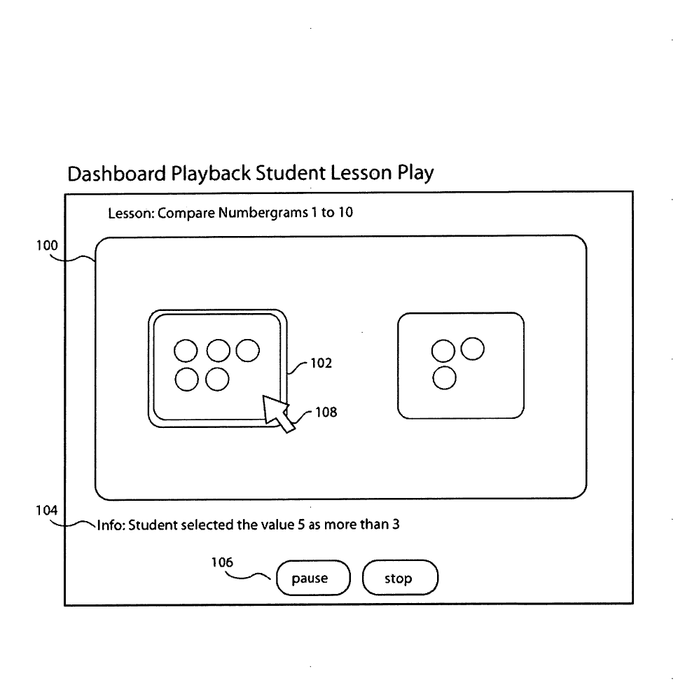

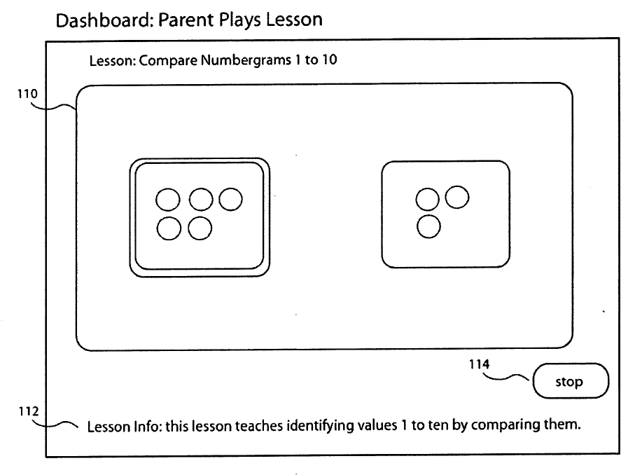

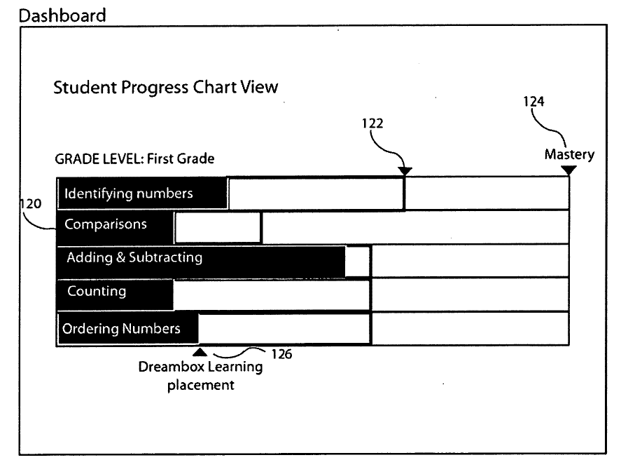

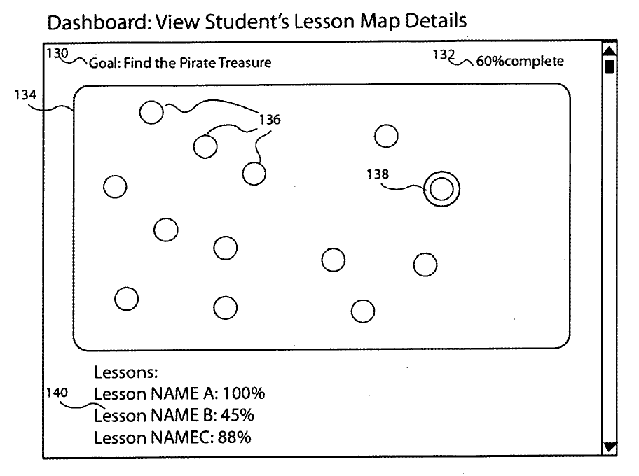

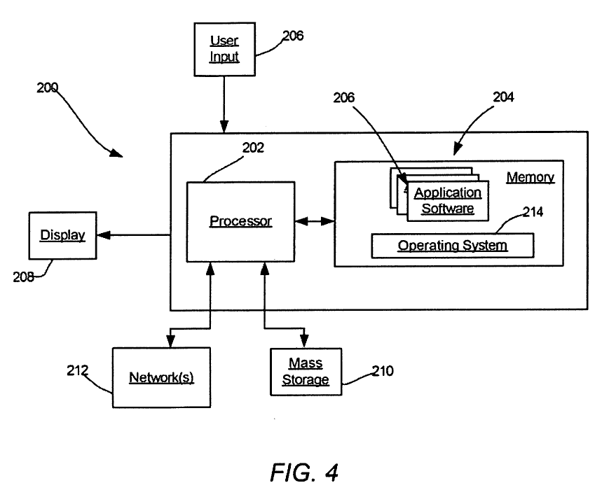

One embodiment of the present invention involves the presentation of a “reviewer dashboard” or “dashboard” to a parent or teacher. In one embodiment, the dashboard may comprise one or more web pages that organizes and presents information about a child's interaction with the system 10. FIG. 3a shows a main page 90 of a dashboard generated for a particular parent, in accordance with one embodiment. As will be seen, the page 90 comprises a Settings tab, and a tab for each child that was registered to the parent, in this case the children Jane, Peter, and Paul. Activation or selection of the Settings tab results in the parent being shown a settings page where the registration settings described above may be modified. From the settings page the parent can set and manage email alerts/notifications e.g. for when a child achieves goals (various levels of notification may be set); to receive weekly status emails; to receive notifications if a child does not use the system 10 at specified intervals; upon completion of an activity/objective/milestone; and reminders to prompt use.

Activation of the tab for each child causes the parent to be shown the aspects of the dashboard pertaining to the child. For example, if the tab for Jane were activated then the parent will be shown the web page 92 (see FIG. 3b), which contains a detailed report on Jane's interaction with the system 10. As will be seen the web page 92 comprises a “Progress” tab, a “Milestones” tab, a “Usage” tab, a “Replay” tab, a “Resources” tab, and a “Contact Us” tab.

Under the Progress tab, the parent may be shown metrics on Jane's progress within the network-based educational system 10; Jane's mastery of skills mapped to objectives within Jane's grade level; and Jane's progress mapped to local/national standards.

Under the Milestones tab, milestones that Jane has reached may be viewed. As noted above, these milestones may be predefined by the system 10 or they may be defined by the parent.

Under the Usage tab, usage metrics collected by the usage monitor 18 may be viewed. The usage metrics may comprise the amount of time spent using the system 10 e.g. by session, or by range of dates e.g. weekly, monthly, etc. The usage metrics may also comprise the days in a week the system 10 was used, an indication of the days that Jane appeared to demonstrate an increased learning ability, Jane's missed days i.e. the days that Jane did not use the system 10; and the days that Jane showed a diminished capacity for learning.

Under the Replay tab, the parent can view a replay or recreation of a representative interaction that Jane had with the system 10 as recorded by the recording module 20.

Under the Resources tab, the parent may be provided with tips and suggestions in connection with Jane's learning, print offline activities to supplement Jane's learning; and read about example activities and other suggestions for extending Jane's learning outside of the system 10.

Under the Contact Us tab, the parent my be presented with a web page whereby the parent may communicate with the operator of the system 10 to submit feedback, make feature requests, and to report bugs. Additionally, under the contact us tab, a parent can participate in polls and surveys.

The concept of providing a detailed report (in the form of an interactive dashboard) on a learner's/student's interaction with the system 10 has been described above. By way of further illustration of the interactive dashboard of the present invention, reference is now made to FIG. 3 of the drawings. In FIG. 3a, a sequence of views/screenshots is provided to a reviewer e.g. in the form of a parent responsive to the parent selecting a “playback” button. The purpose of the sequence of views is to show the reviewer the exact interactions that the learner had with the system 10. In the example of FIG. 3a, the screenshot is to show that reviewer what the learner did responsive to being given the problem of comparing two numbers (5 and 3) given in numbergram form. The numbergrams can be seen in the area labeled 100. The parent can see that the child selected the numbergram corresponding to the number 3 and labeled as 102 in FIG. 3a. In one embodiment, the exact movement of the mouse 108 may be shown in the so that the parent can gain a better understanding of how the child is interacting with the system 10. In the area 104 the parent is given information on the problem being solved. Reference number 106 indicates controls to pause and resume playback.

In one embodiment of the interactive dashboard of the present invention, a parent is given an option to play a lesson to gain a better understanding of the lesson. FIG. 3b shows a screenshot corresponding to the lesson of FIG. 3a where a student is given the problem of comparing two numbers in numbergram form. In the area 110 the parent is given the numbers 5 and 3 in numbergram form. In the area 112, the parent is given information about the lesson. Reference numeral 114 indicates a control to stop/continue the lesson.

Referring now to FIG. 3c of the drawings, a student progress chart is shown, in accordance with one embodiment of the invention. The student progress chart is part of the interactive dashboard of the present invention and includes bars 120 that show a student's skills placement after an initial assessment lesson. Reference numeral 122 indicates the students current level in relation to mastery of the skill as indicated by reference numeral 124. A breakdown of specific content associated with a skill may be obtained by selecting a link associated with the skill as indicated by reference numeral 126. The breakdown of content may be by grade level. In the area 130 the reviewer is given the goal name a learner is familiar with e.g. “find the Pirate Treasure”. The area 132 shows the learner's overall progress in relation to the goal. The area 134 provides a lesson map that the learner sees. For example, the map may be of a pirate island where the learner may find treasure. The circles 136 represent individual lessons that the learner must complete/master in order to get the treasure. Reference numeral 138 indicates the last lesson that the learner completed. In the area 140, the parent/reviewer is presented with a listing of lessons and a percentage completion associated with each lesson. A reviewer can use the map of FIG. 3d to get an overall sense of a learners progress and can then choose to use the playback feature described above to playback a lesson to gain an understanding how the learner is doing in the system.

The screenshot of FIG. 3d of the drawings forms part of the interactive dashboard of the present invention, in one embodiment. In FIG. 3d, the reviewer is presented with a map of a learner's progress in the system 10.

Advantageously, the interactive dashboard of the present invention can be used to give a parent valuable insight into a child's learning. Embodiments of the interactive dashboard of the present invention can be used by parents to:
Manage their account information
   Billing information
   Account settings
      Login
      password
   Email address
View child's use of the system from any computer
   Progress in the system
      Minutes, Questions answered, Scores, Days used.
      Types of lessons played.
      Provide different views of the data
      Amount of time spent using the product
         By session
         By range of dates (weekly monthly)
   Child's progress of skills mapped to objectives within grade level.
   Child's progress mapped to local/national standards
View example questions and definitions of learning experiences
View detailed information about the learning experiences their child has used
   Specific concepts learned
   What specific themes and content their child is using (Example: dinosaurs, pirates and space are favorite themes)
      Examples of graphics and themes to review
Set and manage email alerts/notifications
   When child achieves goals
      Various levels of notification may be set
   Weekly status emails
   Notification if child doesn't use software at certain intervals
   Completion of activity/objective/milestone occurs.
   Reminders to prompt use
Communicate with the system
   Submit feedback requests and bugs
   Fill out polls and surveys
Read tips and suggestions about their child's learning
Print out offline activities
Read about example activities suggestions for extending the learning outside of computer experience.
Add customized aspects to their child's experience:
   Birthdates.
   Confirm correct audio pronunciation of their child's name.
   A special message from parents.
   Upload a photo.

In one embodiment, the dashboard may provide a parent with a “trophy movie” which glues together all the goal point animations and the goal animation as a “trophy” the child can replay.

FIG. 5 of the drawings shows an example of hardware 200 that may be used to implement the client device 14 or the server 12, in accordance with one embodiment of the invention. The hardware 200 typically includes at least one processor 202 coupled to a memory 204. The processor 202 may represent one or more processors (e.g., microprocessors), and the memory 204 may represent random access memory (RAM) devices comprising a main storage of the hardware 200, as well as any supplemental levels of memory e.g., cache memories, non-volatile or back-up memories (e.g. programmable or flash memories), read-only memories, etc. In addition, the memory 204 may be considered to include memory storage physically located elsewhere in the hardware 200, e.g. any cache memory in the processor 202, as well as any storage capacity used as a virtual memory, e.g., as stored on a mass storage device 210.

The hardware 200 also typically receives a number of inputs and outputs for communicating information externally. For interface with a user or operator, the hardware 200 may include one or more user input devices 206 (e.g., a keyboard, a mouse, etc.) and a display 208 (e.g., a Liquid Crystal Display (LCD) panel).

For additional storage, the hardware 200 may also include one or more mass storage devices 210, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 200 may include an interface with one or more networks 212 (e.g., a local area network (LAN), a wide area network (WAN), a wireless network, and/or the Internet among others) to permit the communication of information with other computers coupled to the networks. It should be appreciated that the hardware 200 typically includes suitable analog and/or digital interfaces between the processor 202 and each of the components 204, 206, 208 and 212 as is well known in the art.

The hardware 200 operates under the control of an operating system 214, and executes various computer software applications, components, programs, objects, modules, etc. indicated collectively by reference numeral 216 to perform the above-described operation of the client device 32 or the server 10. In the case of the server 10 various applications, components, programs, objects, etc. may also execute on one or more processors in another computer coupled to the hardware 200 via a network 212, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A method, comprising:
performing a recording operation wherein a recording is made of representative aspects of a learner's interaction with a learning system; and
performing a reviewing operation to present the recording to a reviewer.

2. The method of claim 2, wherein the recording comprises a screen replay of the learner's interaction with the learning system.

3. The method of claim 1, wherein the recording comprises a textual account of the learner's interaction with the learning system.

4. The method of claim 1, further comprising generating a reviewer dashboard comprising at least one web page that includes information about the learner's interaction with the learning system, the dashboard including a button which when selected causes the learning system to perform the reviewing operation.

5. The method of claim 4, wherein the dashboard provides an option to the reviewer to have a particular lesson from the learning system to be played to the reviewer.

6. The method of claim 5, wherein the dashboard provides at least one option to the reviewer to customize content in the system for the learner.

7. The method of claim 6, wherein the at least one option allows the reviewer to customize the content by selecting a theme associated with lessons in the learning system.

8. The method of claim 6, wherein the at least one option allows the reviewer to customize the content by indicating culturally relevant material to the learner.

9. The method of claim 4, wherein the dashboard comprises an indication of the days when the learner had an increased capacity for leaning.

10. The method of claim 4, wherein the dashboard comprises an indication of the days when the learner had a decreased capacity for leaning.

11. The method of claim 4, wherein the dashboard provides the reviewer an option to set an inactivity period being a duration for which the learner does not use the leaning system before the leaning system will notify the reviewer of the learner's failure to use the leaning system.

12. The method of claim 4, wherein the dashboard comprises a mapping of the learner's performance to an academic standard.

13. A learning system, comprising:
a recording module make a recording of representative aspects of a learner's interaction with the learning system; and
a playback function to present the recording to a reviewer.

14. The learning system of claim 13, wherein the recording comprises a screen replay of the learners interaction with the learning system.

15. The learning system of claim 13, wherein the recording comprises a textual account of the learner's interaction with the learning system.

16. The learning system of claim 13, further comprising a function to generate a reviewer dashboard comprising at least one web page that includes information about the learner's interaction with the learning system, the dashboard including a button which when selected causes the learning system to perform the reviewing operation.

17. The learning system of claim 16, wherein the dashboard provides an option to the reviewer to have a particular lesson from the learning system to be played to the reviewer.

18. The learning system of claim 16, wherein the dashboard provides at least one option to the reviewer to customize content in the system for the learner.

19. The learning system of claim 18, wherein the at least one option allows the reviewer to customize the content by selecting a theme associated with lessons in the learning system.

20. The learning system of claim 16, wherein the dashboard comprises a mapping of the learners performance to an academic standard.
